(19) United States
(12) Patent Application Publication
(10) Pub. No.: US 2010/0130644 A1
(43) Pub. Date: May 27, 2010

(54) Use of Adducts of Ethylene and/or Propylene Oxide with Fatty Alcohols as Coalescents

(75) Inventors: Shailesh C. Shah, Dresher, PA (US); Heinz-Gunther Schulte, Kaarst (DE); Ludwig Schieferstein, Ratingen (DE); Harald Frommelius, Monheim (DE); Edda Bergmann, Niederkassel (DE)

Correspondence Address: Joseph F. Posillico;Fox Rothschild LLP, 20th Floor, 2000 Market Street, Philadelphia, PA, 19103, US

(73) Assignee: COGNIS IP MANAGEMENT GMBH, Duesseldorf (DE)

(21) Appl. No.: 12/619,243

(22) Filed: Nov. 16, 2009

(30) Foreign Application Priority Data
Nov. 15, 2008 (EP) 08019980.5

(51) Int. Cl. C08K 5/1515; C08C 1/08

(52) U.S. Cl. 523/335; 524/114

(57) ABSTRACT

Adducts (A) of ethylene oxide and/or propylene oxide with fatty alcohols having 8 to 22 C atoms are suitable as coalescents, more particularly in the production of coatings of any kind based on aqueous polymer dispersions and latex dispersions.

### CROSS REFERENCE TO RELATED APPLICATIONS

This application claims priority to European patent application number 08019980.5 filed Nov. 15, 2008 which is incorporated herein by reference in its entirety.

### FIELD OF THE INVENTION

The invention pertains to the use of certain adducts of ethylene oxide and/or propylene oxide with fatty alcohols as coalescents.

### BACKGROUND OF THE INVENTION

Coalescents (also called film-forming assistants) are known per se. They are added to aqueous coating materials where they cause filming of the dispersed polymer particles to give a homogeneous coating film. Their addition is needed when the film-forming temperature of the binder is situated above the temperature of the application.

Known film-forming assistants are as follows: ethylene glycol ethyl ether, ethylene glycol propyl ether, ethylene glycol butyl ether, ethylene glycol hexyl ether, diethylene glycol methyl ether, diethylene glycol ethyl ether, diethylene glycol butyl ether, diethylene glycol hexyl ether, propylene glycol n-butyl ether, dipropylene glycol n-butyl ether, dipropylene glycol methyl ether, tripropylene glycol methyl ether, propylene glycol phenyl ether, propylene glycol t-butyl ether, 2,2,4-trimethyl-1,3 -pentanediol monoisobutyrate, 2,2,4-trimethyl-1,3-pentanediol diisobutyrate (see “Farbe+Lack”, 101(7/1995), pp. 606-609).

In recent times, water-based coatings have acquired great currency, on environmental grounds. Traditionally, in latex coatings, based in particular on small particles of synthetic polymers such as polyacrylates, coalescents have been used in substantial volumes. These coalescents (also called filming assistants) are added to the coatings in order to improve film formation. Their function derives from the plasticizing action the coalescent has on the latex particles, enabling these particles to flow together and to form a continuous film. This film has optimum properties after the evaporation of the water. Significant in the context of the formation of a film is the temperature referred to as the film-forming temperature, at which (or below which) the polymer particles flow together to form a film. The customary coalescents lower the film-forming temperature of the polymer.

Conventional coalescents are certain esters and ethers; known technical standards are the hydroxy ester “Texanol” from Eastman (also often called TMB; a 2,2,4-trimethyl-1,3-pentanediol monoisobutyrate) and “EGBE” from Union Carbide (ethylene glycol monobutyl ether).

### DETAILED DESCRIPTION OF PREFERRED EMBODIMENTS

There is a continual need for new coalescents. The object of the present invention was therefore to provide coalescents. These coalescents ought to be suitable more particularly for the production of coatings such as paints, inks and the like, but also for adhesives. A particularly preferred field for the use of the coalescents to be prepared is that of what are referred to as emulsion paints.

The concept of the coalescents (in the literature also called filming assistants or film-forming assistants) is to be understood in the sense set out above, which is very familiar to the skilled worker.

It may expressly be noted that the coalescents to be developed in accordance with the invention are intended more particularly for use in aqueous dispersions of polymers or latex particles that are suitable for coating purposes of any kind (for example, for water-based paints and inks).

Dispersions of this kind which are typically prepared by emulsion polymerization and which as well as water, the auxiliaries used in emulsion polymerization, and the polymer particles or latex particles may comprise further constituents that are typically used for the particular desired coating purpose, are typically applied to the surface to be coated, after which the water is evaporated and, finally, it is essential that the polymer particles or latex particles flow into one another (“coalesce”), and form a homogeneous film. For this process of film formation to take place it is necessary to observe at least a minimum temperature which is referred to by the skilled worker as the minimum film formation temperature (MFFT). Where the MFT of a system is 20° C., for example, this means that film formation proceeds successfully only when the temperature is 20° C. or more. If, on the other hand, film formation is to be brought about at lower temperatures, for example, 10° C. or even lower temperatures, then the stated aqueous dispersions must be admixed with a coalescent in an amount such that the MFFT is lowered to the desired figure.

In this respect, the present invention has set itself the objective, more particularly, of developing coalescents which very effectively lower the MFFT of aqueous dispersions of polymer particles or latex particles that are intended for any desired coating purposes.

It was a further objective of the present invention to develop coalescents which feature an extremely low VOC content (VOC=volatile organic carbon).

A further objective of the present invention was to develop coalescents which have the additional advantage of acting as solubilizers for polyurethane-based associative thickeners.

The invention provides for the use of adducts (A) of ethylene oxide and/or propylene oxide with fatty alcohols having 8 to 22 C atoms as coalescents. The fatty alcohols in this case may be saturated or unsaturated, straight-chain or branched.

Examples of suitable fatty alcohols contemplated as components of the adducts (A) are, for instance, octanol, decanol, dodecanol, tetradecanol, hexadecanol. These fatty alcohols are among the saturated fatty alcohols. In the context of the present invention they are used with preference as fatty alcohol components of the adducts (A). Fatty alcohols of natural origin are preferred in this context.

In one embodiment the fatty alcohol component of the adducts (A) is selected from fatty alcohols having 12 to 14 C atoms.

In one embodiment the adducts (A) are selected from the following compounds:

(a1) are obtainable by reacting 1 to 6 mol of ethylene oxide with fatty alcohols having 8 to 18 C atoms and

(a2) are obtainable by reacting 2 to 8 mol of ethylene oxide and 1 to 6 mol of propylene oxide with fatty alcohols having 8 to 18 C atoms.

In a preferred embodiment the adducts (A) are selected from the following compounds:

(a1*) are obtainable by reacting 3 to 6 mol of ethylene oxide with fatty alcohols having 8 to 18 C atoms and

(a2*) are obtainable by reacting 2 to 8 mol of ethylene oxide and 2 to 6 mol of propylene oxide with fatty alcohols having 8 to 18 C atoms.

Examples of the compounds (a1) and (a1*) are obtainable for instance through reaction of 4 mol of ethylene oxide with 1 mol of octanol.

Examples of the compounds (a2) and (a2*) are obtainable for instance through reaction of 2 mol of ethylene oxide and 4 mol of propylene oxide with 1 mol of a mixture of dodecanol and tetradecanol, of 3 mol of ethylene oxide and 6 mol of propylene oxide with 1 mol of a mixture of dodecanol and tetradecanol, of 5 mol of ethylene oxide and 4 mol of propylene oxide with 1 mol of a mixture of dodecanol and tetradecanol. The three last-mentioned compounds are commercial products of the company Cognis and are available under the designations Lorol LS24, LS36, and LS54.

In one embodiment, the abovementioned adducts (A) are employed in the production of coatings of any kind based on aqueous polymer dispersions or latex dispersions.

One particularly preferred field for the use of adducts (A) as coalescents is that of what are known as (water-based or aqueous) emulsion paints.

The adducts (A) are very efficient coalescents, as evident from the fact that they have an excellent capacity to lower the minimum film formation temperature (MFFT) of aqueous polymer dispersions.

The adducts (A) for use in accordance with the invention can be employed in pure form or in the form of mixtures with one another. If desired the adducts (A) can also be employed in combination with known coalescents.

As already stated, the adducts (A) to be used in accordance with the invention are employed more particularly as coalescents for aqueous dispersions of polymer particles or latex particles from which a film is to be formed. This applies either when the adducts (A) are used alone (in the form of a pure species or a mixture of different species) or in a blend with other—different—coalescents.

The adducts (A) are employed in these contexts preferably (depending on the MFFT of the polymer) in amounts of 0.1% to 40% and more particularly 2% to 6% by weight, based on the amount of the polymer particles or latex particles whose minimum film formation temperature is to be lowered.

From another viewpoint, the amount of the adducts (A) may be referred to a completed coating formula which is to be applied to a surface. In this respect, the adducts (A) are employed preferably (according to the MFFT of the polymer) in amounts of 0.1% to 5% and more particularly 0.5% to 2% by weight, based on the overall coating formula.

The skilled worker is able to vary the amount of the adducts (A) in accordance with the composition of a specific dispersion or a specific coating formula and, as and when necessary, is able to use higher amounts of adducts (A) as well, especially if the system comprises polymers having a high minimum film formation temperature and/or if lowering to extremely low MFFT values is intended.

One preferred embodiment uses compositions comprising

(i) one or more of the abovementioned adducts (A) and

(ii) one or more associative thickeners

as coalescents.

One embodiment uses these compositions in the production of coatings of any kind based on aqueous polymer dispersions or latex dispersions or based on aqueous emulsion paints.

With regard to the nature of the polymer particles or latex particles that are present in the aqueous dispersions there are no particular restrictions. It is therefore possible to use all of the polymers and copolymers that are relevantly known to the skilled worker for coating purposes.

Depending on the desired application and/or on the nature of the coating, moreover, the aqueous dispersions may comprise further adjuvants and additives that are relevantly known to the skilled worker.

The adducts (A) of the invention may be added to the aqueous dispersions immediately after their preparation, which is accomplished preferably by emulsion polymerization, or else at a later point in time, as for instance during the production of a coating material.

The aqueous dispersions comprising adduct (A) for use in accordance with the invention may be applied in principle to any desired surfaces, as for example to wood, metal, plastic, glass, paper, concrete, masonry and renders.

### EXAMPLES

### Abbreviations

Unless explicitly noted otherwise, percent figures are percent by weight.

### Substances Employed

DSX 3290 Polyurethane-based associative thickener (Cognis)
Acronal 290D Aqueous polymer dispersion based on butyl acrylate/styrene (BASF)
Rhoplex SG 30 Aqueous polymer dispersion based on acrylic ester (Rohm & Haas)

### Coalescents

A1 Adduct of 2 mol of ethylene oxide and 4 mol of propylene oxide with 1 mol of a 1:1 mixture of dodecanol and tetradecanol
A2 Adduct of 4 mol of ethylene oxide with 1 mol of octanol
A3 Mixture of 50% A1, 5% DSX 3290 and 45% 1,2-propylene glycol
A4 Mixture of 60% A2, 5% DSX 3290 and 35% water
C1 Mixture of 95% 1,2-propylene glycol and 5% DSX 3290

Coalescents A1 to A4 comprise the adducts of ethylene oxide and/or propylene oxide with fatty alcohols having 8 to 22 C atoms, for use in accordance with the invention. C1 is a coalescent which serves for comparison.

### Production and Assessment of the Coatings

The addition of the test coalescent (A1, A2, A3, A4 or C1) to the respective polymer dispersion took place with stirring. Then, after a 24-hour aging period, the minimum film formation temperature (MFFT) was ascertained. The minimum film formation temperature (MFFT) was tested in accordance with DIN 53787. The test results can be seen in table 1.

TABLE 1

| | |
|---|---|
| Acronal 290 D | Rhoplex SG 30 |

MFFT [° C.]

| | No | 2% | 3% | No | 2% | 3% |
|---|---|---|---|---|---|---|
| | additive | additive | additive | additive | additive | additive |
| C1 | 20 | 17 | 15 | 13 | 13 | 13 |
| A1 | 21 | 9 | | | | |
| A2 | 22 | 9 | | | | |
| A3 | 20 | 14 | 12 | 13 | 11 | 9 |
| A4 | 20 | 14 | 13 | 13 | 11 | 9 |

in table 1:
% additive (A1, A2, A3, A4 or C1) = the amount of coalescent added to the aqueous dispersion is expressed in % by weight, based on the polymer dispersions (in the form as supplied by the manufacturer).

As is apparent from table 1, the MFFT is lowered by the addition of the additive. Therefore, the additive is a coalescent.

In addition to their suitability as coalescents, the inventive adducts A1 and A2 and their mixtures A3 and A4 have the additional advantage of acting as solubilizers for polyurethane-based associative thickeners.

What is claimed is:

1. A method of assisting film forming comprising adding at least one adduct (A) of ethylene oxide and/or propylene oxide with at least one fatty alcohol having 8 to 22 carbon atoms, as a coalescent.

2. The method of claim 1, wherein the fatty alcohol component of said adduct (A) is selected from fatty alcohols having from 12 to 14 carbon atoms.

3. The method of claim 1, wherein said adduct (A) is selected from the group of compounds consisting of those obtained (a1) by reacting 1 to 6 mol of ethylene oxide with at least one fatty alcohol having 8 to 18 carbon atoms, and (a2) by reacting 2 to 8 mol of ethylene oxide and 1 to 6 mol of propylene oxide with at least one fatty alcohol having 8 to 18 carbon atoms, and mixtures thereof.

4. The method of claim 1, wherein said adduct (A) is selected from the group of compounds consisting of those obtained (a1) by reacting 3 to 6 mol of ethylene oxide with at least one fatty alcohol having 8 to 18 carbon atoms, and (a2) by reacting 2 to 8 mold of ethylene oxide and 2 to 6 mol of propylene oxide with at least one fatty alcohol having 8 to 18 atoms, and mixtures thereof.

5. The method of claim 1 wherein the addition of the coalescent results in the production of a coating based on an aqueous polymer dispersion or latex dispersion.

6. The method of claim 5 wherein said polymer dispersion or latex dispersion comprises an aqueous emulsion paint.

7. The method of claim 1 further comprising one or more associative thickeners as a coalescent.

8. The use as claimed in claim 6 in the production of coatings of any kind based on aqueous polymer dispersions or latex dispersions.

9. The method of claim 6 further comprising one or more associative thickeners as a coalescent.
